(19) United States
(12) Patent Application Publication
(10) Pub. No.: US 2002/0099735 A1
(43) Pub. Date: Jul. 25, 2002

(54) System and method for conducting electronic commerce

(76) Inventors: Jonathan E. Schroeder, Columbus, OH (US); Eric C. Yu, Westerville, OH (US); Jeffrey A. Crist, Sunbury, OH (US)

Correspondence Address: John H. D' Antico, Brobeck, Phleger & Harrison LLP, 4801 Plaza on the Lake, Austin, TX, 78746, US

(21) Appl. No.: 09/767,422

(22) Filed: Jan. 19, 2001

(51) Int. Cl. G06F 17/21; G06F 17/22

(52) U.S. Cl. 707/513; 707/523

(57) ABSTRACT

A method of processing data exchanged between a first trading partner and a second trading partner includes receiving a first data file from the first trading partner, the first data file having a first file format and being an electronic representation of at least one document. The method further includes translating the received first data file into at least one second data file having an XML file format and transforming each of the at least one second data files into a normalized third data file having an XML file format, wherein the third data file is normalized according to a data format associated with the second trading partner.

### CROSS-REFERENCES TO RELATED APPLICATIONS

### STATEMENT REGARDING FEDERALLY SPONSORED RESEARCH OR DEVELOPMENT

### MICROFICHE APPENDIX

### BACKGROUND OF THE INVENTION

This invention relates generally to business-to-business electronic commerce and more particularly to a system and method for conducting electronic commerce.

Business-to-business electronic commerce has traditionally been conducted using electronic data interchange, which is commonly known as “EDI.” To facilitate the transfer of data from one account to another using EDI, defined formats had to be established. As formats developed, generally the large companies within an industry would define how they wanted to obtain and send data. Smaller companies that worked with that large company would necessarily have to agree to the large company's format. Thus, each company that wanted to electronically exchange data with that large company needed to put their data in that set format. This limitation required each company to use formatting technology to convert data from their internal system to the format required by their business partner. Eventually, EDI translation software became available which allowed companies to transform their proprietary data format into another defined format.

However, installing, configuring, maintaining and supporting EDI translation software was and continues to be a difficult, time-consuming and expensive task. Only companies with the financial resources to hire dedicated personnel to support the EDI translation software found a positive return on their EDI investment. Many companies found that only a small portion of the companies with whom they did business were actually willing to use EDI because of the complications that necessarily came with the approach. Thus, the cost and complexity faced by the smaller companies prevented them from doing business electronically. As a result, EDI has not achieved its goal of providing a universal format for business-to-business commercial transactions.

Many current translation products used to conduct electronic commerce are implemented using specific proprietary formats that do not allow for easy portability of data or integration with other applications. For example, they do not allow data translation products used in electronic commerce to seamlessly integrate with other developed applications to create more robust platforms and integrated purchasing and inventory solutions. Thus such current translation products cannot be easily leveraged to share data, notification channels, and process flows with other products. Additionally, the need for manual data entry, review, and manipulation by a user means such current translation products are slower and less automated. The deployment and implementation of translation solutions such as translation maps between data formats are very slow as a result.

Accordingly, a need remains for a system that facilitates electronic commerce between companies without the need for mandated data formats such as EDI and expensive and complicated application software to be owned and maintained by companies.

### SUMMARY OF THE INVENTION

The present invention removes the cost and complexity of prior approaches used for conducting business-to-business electronic transactions. Specifically, various embodiments of the present invention enable a company to have effective electronic business-to-business commerce with all of its trading partners regardless of their size or technical sophistication. Among other things, such embodiments do this by allowing companies to use their current business preferences and systems in electronic commerce, rather than requiring companies to change their preferences and systems to meet a fixed standard imposed by a trading partner or standard setting body (e.g., ANSI).

In one embodiment of the present invention, a method of processing data exchanged between a first trading partner and a second trading partner is disclosed that includes receiving a first data file from the first trading partner, the first data file having a first file format and being an electronic representation of at least one document. The method further includes translating the received first data file into at least one second data file having an XML file format and transforming each of the at least one second data files into a normalized third data file having an XML file format, wherein the third data file is normalized according to a data format associated with the second trading partner.

One advantage of various embodiments of the present invention is that the data file can be translated to any number of different formats without referring back to the source data file. Thus, various embodiments of the present invention accept a data file from one company (“Sending Company”), regardless of the format used by the Sending Company. Within that data file may be several documents (e.g., purchase orders) relating to a number of different transactions. Each document may be destined for a different company (“Receiving Company”). Various embodiments of the present invention also offer additional advantages in the way the data is delivered and presented to the Receiving Company.

A further advantage of various embodiments of the present invention is the ability to search all data sent to the system. The use of the XML format also allows the data sent to the system to be viewed through a standard Web browser without any need for further data translation. It also allows customers to develop robust customer applications that utilize the XML data while maintaining the integrity of the original source data.

Various embodiments of the present invention also provide a neutral infrastructure to support comprehensive communications between businesses electronically without restricting the form of those activities.

Various embodiments of the present invention additionally allow for automation of tasks that were previously done manually in a time consuming manner. Such automation significantly lowers the operational costs for users of such embodiments and significantly reduces the time needed to get trading partners enabled and trading solutions deployed, which in turn enables thousands of trading partners to be enabled for business-to-business transactions very quickly. Other products and processes lack this ability and require many more manual steps and much higher cost to achieve similar results.

Many current translation products used to conduct electronic commerce are designed solely as translation products and as such do not additionally provide a platform for the easy building or integration of business-to-business applications that rely on business-to-business information exchange. For example, they do not feature multiple application programming interfaces that allow applications, such as vendor managed inventory systems, to be built directly into translation, rules and messaging processes. Additionally, the need for manual data entry, review, and manipulation by a user means such current translation products are slower and less automated. The deployment and implementation of translation solutions such as translation maps between data formats are very slow as a result.

The foregoing and other objects, features and advantages of the invention will become more readily apparent from the following detailed description of a preferred embodiment of the invention, which proceeds with reference to the accompanying drawings.

### BRIEF DESCRIPTION OF THE DRAWINGS

FIG. 1 is a data flow diagram of a system of exchanging data among businesses in accordance with the teachings of the present invention;

FIG. 2 is a data flow diagram of the inbound pre-translation process of FIG. 1;

FIG. 3 is a data flow diagram of the inbound post-translation process of FIG. 1;

FIG. 4 is a schematic diagram of the rules engine according to the present invention;

FIG. 5 is a data flow diagram of an alternative embodiment of a system of exchanging data among businesses in accordance with the teachings of the present invention;

FIG. 6 is a flowchart of one embodiment of a process for creating a data definition file according to the teachings of the present invention;

FIG. 7 is a flowchart of an alternative embodiment of a process for creating a data definition file and using the data definition file to translate a data file according to the teachings of the present invention; and

FIG. 8 is a flowchart of an embodiment of using a data definition file to translate a data file.

### DETAILED DESCRIPTION

The present invention provides a unique way for data to be exchanged among businesses. By using various embodiments of the system and method described herein, a business can send a data file in the format they choose and distribute that data to another business in any number of desired formats. The starting point of the system process is the transfer of a data file to a system portal 10 by a business (referred to as a “trading partner”). Each trading partner that uses the system portal is assigned a mailbox that is used to manage the data files that a trading partner sends and receives.

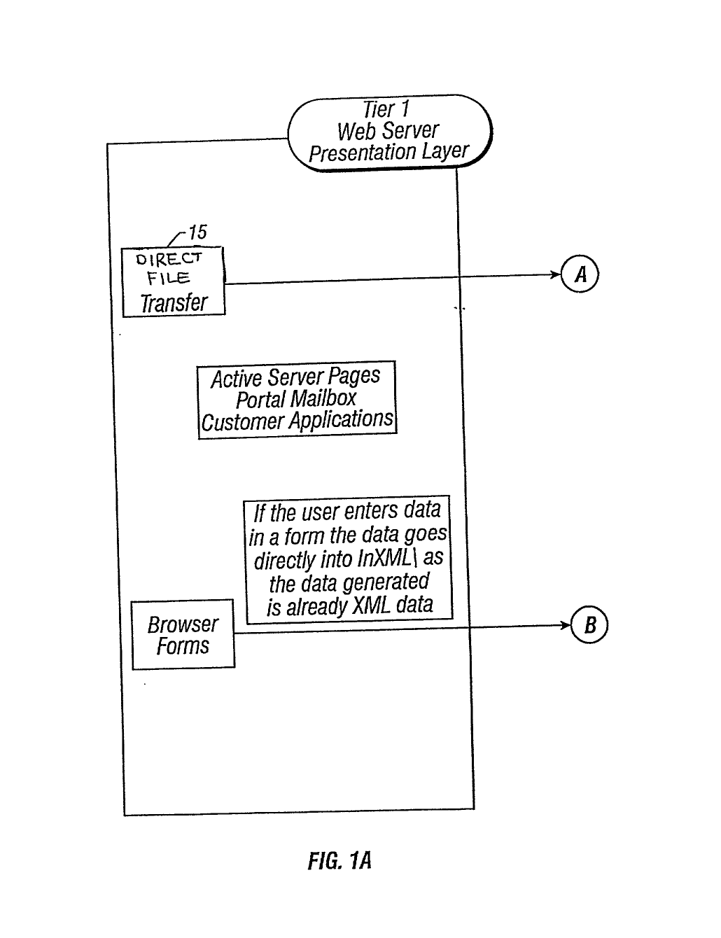

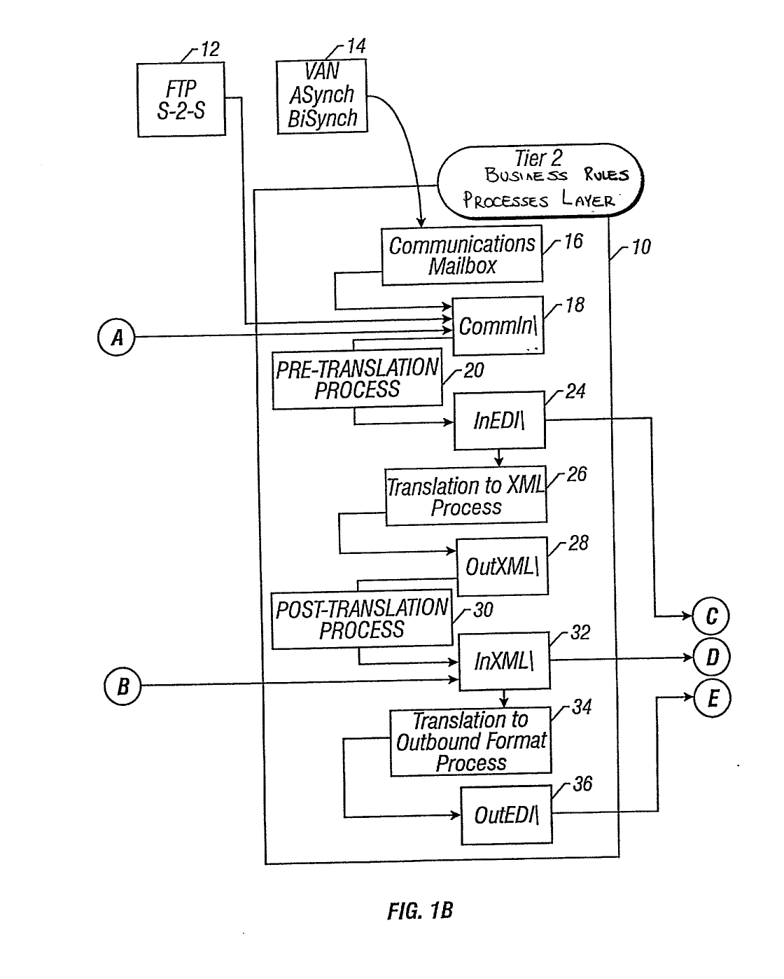

As shown in FIG. 1, data can be transferred to the system portal by any number of commercially reliable data communications methods. The transfer can be directly from a trading partner such as trading partner 12 or from an intermediary such as VAN 14. One such method of data transfer includes a “Post” from an HTML Form, where an HTML form is used within a Web browser for data entry. The data that is entered into the form is transferred to the system portal via secure HTTP as XML data. Another data transfer method is a “Direct File Transfer” 15. In this case, using a Web browser, such as Microsoft's Internet Explorer, a data file is selected from the trading partner's file system and transferred to the system portal via secure HTTP. A further method of transferring data to the system portal is a “Automated File Transfer.” Through the use of communications software (e.g., Cyclone Software), data can be transferred on an unattended scheduled basis from the trading partner's computer system to the system portal as an encrypted data file via FTP, SMTP, and HTTP or secure HTTP. Another example of transfer method is a standard modem-to-modem communications transfer (such as asynchronous and bi-synchronous communications). The data file can be either transmitted to a communication mailbox 16 or directly to a directory COMMIn\18 established on the system portal 10.

A. Inbound Data Process

1. Inbound Pre-translation Process.

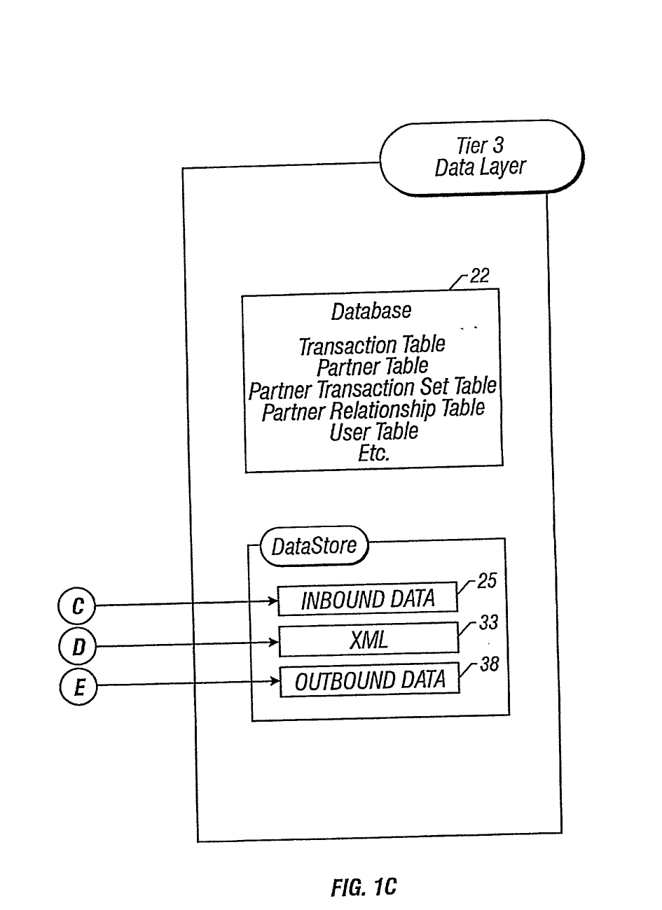

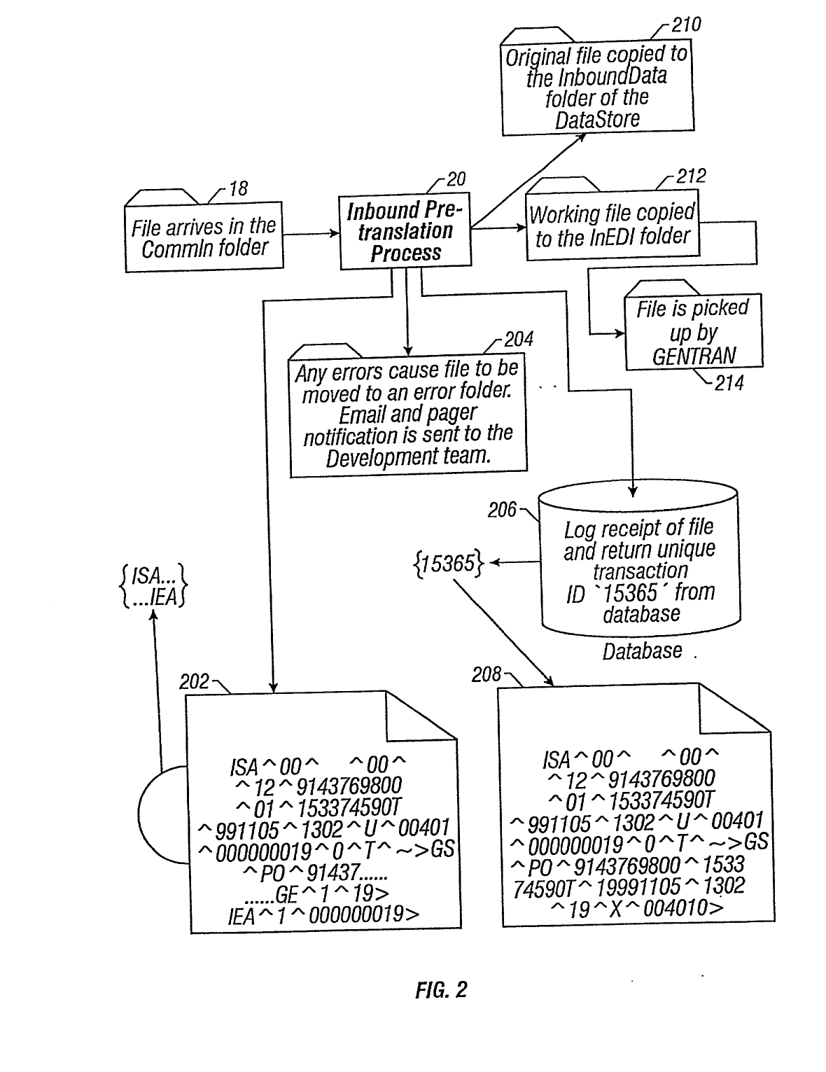

Once the data file is received by the System Portal 10, the data file undergoes a “pre-translation process” 20. Referring again to FIG. 1, if the data file was transferred to the communication mailbox 16, it is moved to the COMMIn\directory 18. A system data agent monitors the COMMIn\directory for new files. As shown in FIG. 2, the system data agent has two purposes. The first purpose is to validate that the data file that was transferred to the system 10 conforms to a predetermined data file structure established by the system. The date agent accomplishes this by scanning the file and comparing the file to a predetermined file format, as shown at 202 in FIG. 2. If the data file does not conform to the established structure or there is a failure during any part of this process, the system 10 takes the following steps (204): the data agent moves the data file to a temporary holding area; a message indicating that an error occurred during this process is sent to a system development organization via e-mail, pager, or some other comparable form of communication; the error is written to an error log file within the file system; and, an entry is written to an error log in the system database 22.

The second purpose of the data agent is to create a record in a system database 22 for each document (e.g., purchase order or invoice) that is contained within the copy of the data file. As the entry is made in database 22, a transaction ID is generated by a SQL server (e.g., “15365”), for example, or any other suitable relational database, as a database index entry. Once the record for the document has been created in the database 22, the record identifier is inserted into the copy of the corresponding document being processed (208). As described further below, another system data agent uses this record identifier later in the process. Upon the completion of this step, the original data file is stored (210) in a system inbound data repository 25. The original file name is combined with a time/date stamp to create a unique file name. The copy of the data file is then copied (212) to the INEDI\folder, where it is picked up by the next process (214) for additional processing.

2. Inbound Translation Process

After the pre-translation process has completed successfully, the original data is normalized to an XML format using a data translation process 26 and maps built for the system. Commercially available translation software, such as that offered by Sterling Commerce under the trade designation GENTRAN, can be used to convert the data file into XML format. The maps specify the position or location in the translated file each datum in the original file is to occupy. The system includes a library of maps from which the user can choose including all the common formats that the system will need to accept from the different businesses. This map library allows trading partners to verify in their browser if their data is in a format that the system can accept. Upon the completion of the translation to XML, the data translation process outputs the XML file to an output directory OUTXML\28 where an inbound post-translation data agent 30 processes the XML file.

3. Inbound Post-translation Process

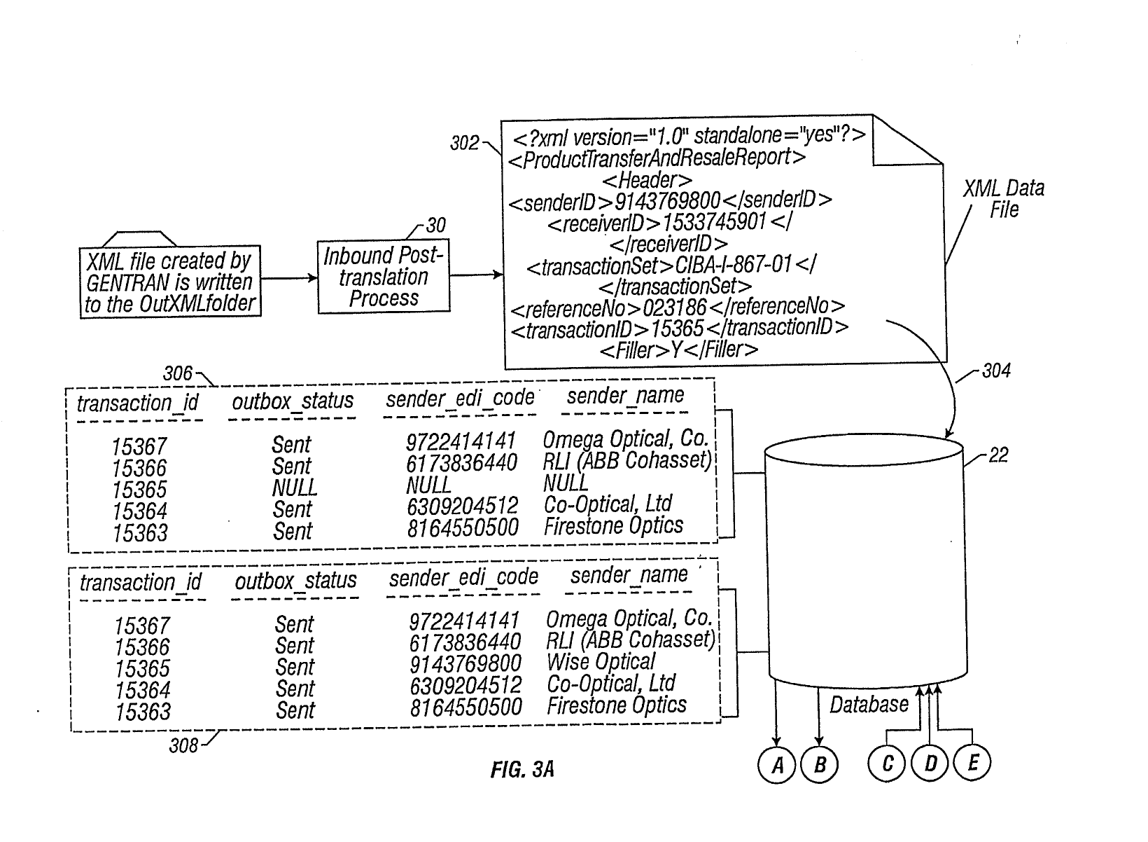

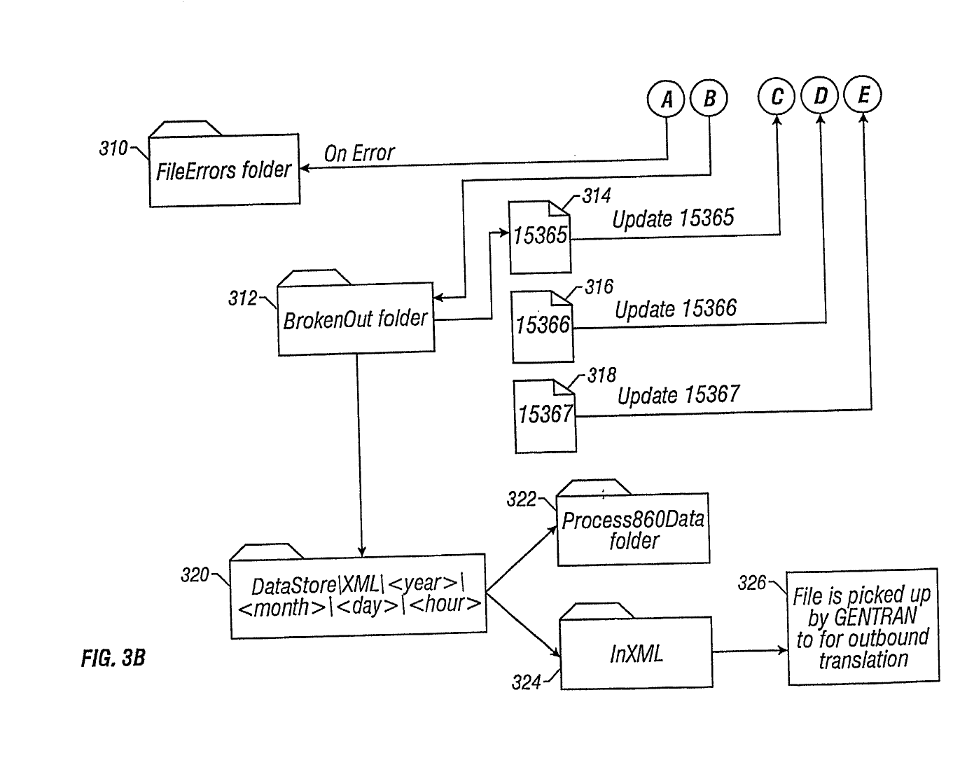

The purpose of the inbound post-translation process 30 is to insert the XML document into the sending trading partner's “Outbox” mailbox and to distribute the individual documents to the “In-box” mailbox of the intended recipient trading partner. This process is shown in FIG. 3. The pre-translation record ID generated and seeded into the source file when the document was recorded in the transaction table of the system database is passed during the translation process through to the XML file 302. The post-translation process 30 then queries the system database 22 for this record ID (e.g., “15365”), as shown at 304. The resulting search returns the record that was created during the pre-translation process (e.g., 306).

As shown in FIG. 3, at this point in the post-translation process the record does not include certain information related to the underlying commercial transaction (e.g., sender EDI code, sender name). Each document within the XML data file is then broken out and placed in a folder (312). Each transaction record that was created during the pre-translation process (e.g., 314, 316, 318) is then updated with sender, the receiver, the document type, the name and location of the XML file in the data repository, as shown at FIG. 3. If the file is a purchase order change request, the post-translation process 30 sends the XML file to another process folder 322, which is monitored by a purchase order change request process agent (not shown). This process agent, upon detecting a new file in folder 322, updates the original purchase order pursuant to the information in the change request.

After each of the document is updated by process 30, the XML file is assigned a unique file name, which is a function of the date and time corresponding to the data file, and stored in folder 320. If a flag in the database 22 has been set for this document type, the file is copied to InXML\folder 324 for outbound processing.

Referring back to FIG. 1, upon the completion of this inbound post-translation process, the sending and receiving trading partners' mailboxes have been successfully populated with documents sent to the System and the XML file is placed into an XMLData data repository. This completes the inbound process.

B. Outbound Data Processes

The outbound data processes translate the XML data to a file format specified by the recipient trading partner. This translation process can occur automatically or dynamically, depending on how the relationship between the recipient trading partner and the system has been established.

1. Outbound Translation Process

If the recipient trading partner has established a relationship with the System operator to automatically translate the data to the recipient's desired file format, the XML file that is processed by the post-translation process is copied into a directory when the post-translation process 30 has successfully completed. Referring again to FIG. 1, this directory is monitored by an outbound data agent that, when a file shows up in the directory, translates the XML file to the desired outbound file format by data translation process 34. When the XML file has been successfully translated to the desired outbound file format, the file is written to a directory OutEDI\36 where an outbound post-translation process 34 is waiting to process the outbound file.

If the recipient trading partner has not established a relationship with the system to automatically translate the data to the recipient's desired file format, the recipient can choose to translate their XML data to a select list of formats defined by the system. The recipient trading partner can choose to download a file in their mailbox and before downloading the file choose the desired file format. Upon making this selection, the XML file would be translated real-time to the format selected by the recipient trading partner.

The outbound translation process can translate a document into any one of a number of different formats such as: a standard EDI format; a defined application layout file, e.g. SAP IDOC structure, Baan, PeopleSoft, QuickBooks, Great Plains; or a comma or tab delimited format for bulk copy into a database or spreadsheet.

2. Outbound Post-translation Process

The purpose of the outbound post-translation process is to insert the outbound file into the receiving trading partner's mailbox. Upon the arrival of an outbound data file, the outbound post-translation data agent opens the file and retrieves the record ID that was seeded into the original source file during the inbound pre-translation process. After retrieving the record ID, the data agent queries the system database 22 for this record ID. The resulting search returns the record that was created during the pre-translation process so that the outbound post-translation process can update this record with the name of the outbound data file and store the outbound data file in an outbound data repository Outbound Data 38.

Upon the completion of this outbound post-translation process, the file is sent or picked up by the recipient trading partner depending on their desired method of receipt. The system 10 provides several different methods for delivering the documents to the intended recipient company. As described above, one such method is to place the document in the recipient company's system mailbox for download by the Receiving Company. Alternatively, the data can be sent directly to the Receiving Company using a communications software such as Cyclone Software. Another alternative provided by the system, is the ability to insert the data real-time into the Receiving Company's business system using software such as webMethods B2B Server. The system also can transmit the data to the Receiving Company's mailbox or a Value-Added Network using any commercially available communications protocol.

Because the system translates the source data file into an XML format, the system offers several options on how the data can be presented to the users. The static XML data can be presented through the Receiving Company's system mailbox in an HTML form. The static XML data also can be presented with dynamic data from alternate data repositories in an HTML form. Finally, the raw XML data can be displayed by downloading the XML file and displaying the data in a Web browser or a third party application. As described above, the system according to the invention offers several advantages in the way the data is sent and displayed.

C. Rules Engine

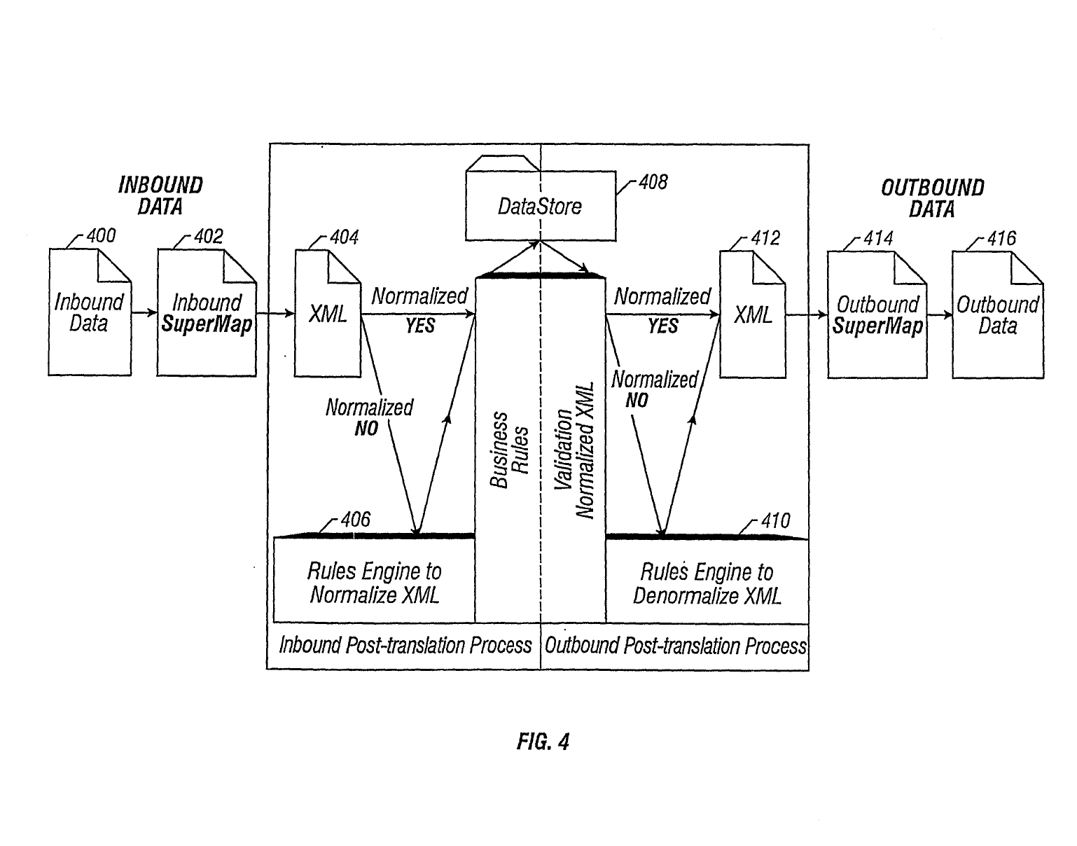

The system according to the present invention includes a rules engine (SmartLogic routine) that is designed to provide two specific capabilities. One is the ability to apply sophisticated business rules or logic against data sent to the system portal. The second is the ability to easily transform or translate data from one XML format to another XML format. This section, with reference to FIG. 4, describes both of these capabilities in detail.

1. XML Transformation

Through the use of XML and XSL (Extensible Stylesheet Language), the SmartLogic routine greatly simplifies the process of normalizing the data received by system. In the past, individual data transformation maps had to be created for each different type of data file that needed to be transformed. For example, the structure of an EDI purchase order file from “Company A” would probably be different than a purchase order file from “Company B”. Because of these differences, different data transformation maps needed to be built to reflect the structure of each of these purchase orders. The result of this was a tremendous amount of time and expense in the creation of each of these customer maps.

The XML transformation capability of the present system streamlines this process greatly by creating generic data transformation maps to generate a pre-normalization XML file and then using XSL and the SmartLogic routine, transforms the pre-normalized XML file into a normalized XML file. The time required to create the XSL to perform this transformation is significantly less than creating a traditional data transformation map. Additionally, this process requires significantly less computer processing resources to perform the transformation.

a. Inbound Data

As shown in FIG. 4, the system uses a generic map 402 (referred to hereinafter as “SuperMap”) to map the data in an incoming document (400) to corresponding segments in a pre-normalization XML document (404). A “SuperMap” is a data transformation map that contains all possible data segments and data elements for a given type of document. For example, an EDI purchase order (known as an 850) version 4010 contains nearly 200 data segments and nearly 2000 data elements as defined by the X12 standards organization. Normally when creating a map for this document type, the map would contain only the segments and elements that were being used thus requiring another map to be defined for each other purchase order format. A “SuperMap” defines all possible data segments and elements as potentially useable segments and elements. By taking this approach, the need for creating individual maps for each variation in an X12 4010 purchase order has been eliminated.

A second step is required to normalize the data to XML because, for any given document format (e.g., EDI), a given data element may be in more than one data segment. For example, one company might send name and address information in a different segment than another company. Because of the flexibility of EDI, both of these companies may be sending the name and address information in valid locations within the EDI. The result of these two valid uses of EDI is that when the EDI data is transformed using a “SuperMap,” the name and address information ends up in two different locations within the resulting XML. Thus, the XML is not normalized. By creating XSL files that defines where the name and address information is located within these XML files, the system can then apply these XSL files against the source XML files using a publicly available XML Parser to generate a normalized XML document.

b. Outbound Data

The mapping process for outbound documents is the mirror image of that for the inbound documents. Like inbound data file structures, the structure of outbound data file formats for the same document types vary from company to company. Again, through the use of XSL, a normalized XML document (412) can be transformed to de-normalized version of XML that complies with the required outbound data structure. This denormalized XML file is then passed to an outbound data transformation “SuperMap” (414) to be transformed to an outbound document (416) in the format expected by the recipient company would like.

2. Business Rules

The ability to apply business rules against data sent to ECO provides ECO with a capability that adds additional value to the ECO solution. Centralizing the location of these business rules within the ECO environment greatly simplifies the management of this offering.

In the past, ECO was able to apply business rules against data that was sent to ECO using an HTML Web form. These rules were essentially built into the Web form as a part of the logic that was created to build the Web form. The rules were not centrally located within the ECO environment and were not written so that other ECO processes could access them.

The RE routine changes this by acting as a central repository for all business rules. This central repository is accessible by all ECO processes and therefore the business rules can be applied against all data that is sent to ECO, regardless of how the data is transported to ECO. Business rules can be applied against the data after the data has been normalized to XML. This allows the rules to be applied against a common XML structure thus simplifying the process of applying rules.

The business rules can be defined in one of two ways. Simpler rules that merely validate whether a value in the data is numeric or whether a value in the data is a valid data can be defined and stored in a table created in the ECO database. More complex rules can be defined by a developer by writing the rule using a programming tool such as Microsoft Visual Basic or Microsoft Visual C++ and then compiling that rule as a COM (Component Object Model) object. This COM object is then referenced within the same table that was described above.

When the RE routine is passed a data file, the RE routine queries the database for rules that have been defined for this particular type of document. The document type is determined by interrogating the document type element of the XML file. The document type element is contained in every normalized ECO XML file. If the query returns a result, the RE routine begins to apply the rules that were returned by the query.

If the rules are all successfully completed, the document is passed to the next step within the process. If the process is for inbound documents, the file is moved to the appropriate mailbox as described in the ECOutlook.com Process document. If the process is for outbound documents, the file is moved to the appropriate directory where the data transformation tool can pick up the file for outbound transformation. If any of the rules fail, the file is written to a holding area, e-mail notification is sent to the ECO Development team as well as the sender of the data to notify them of the problem.

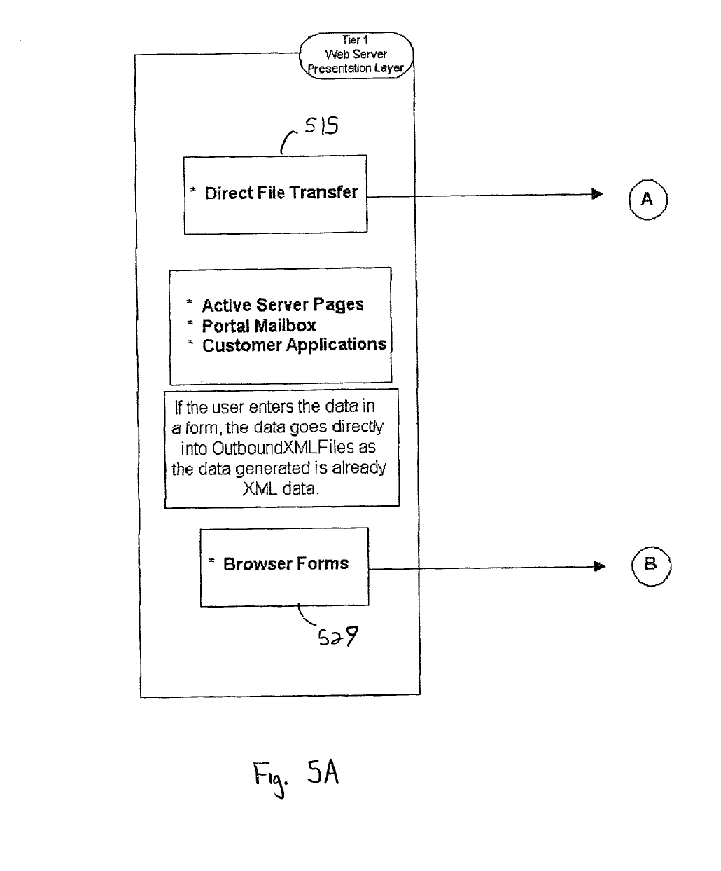

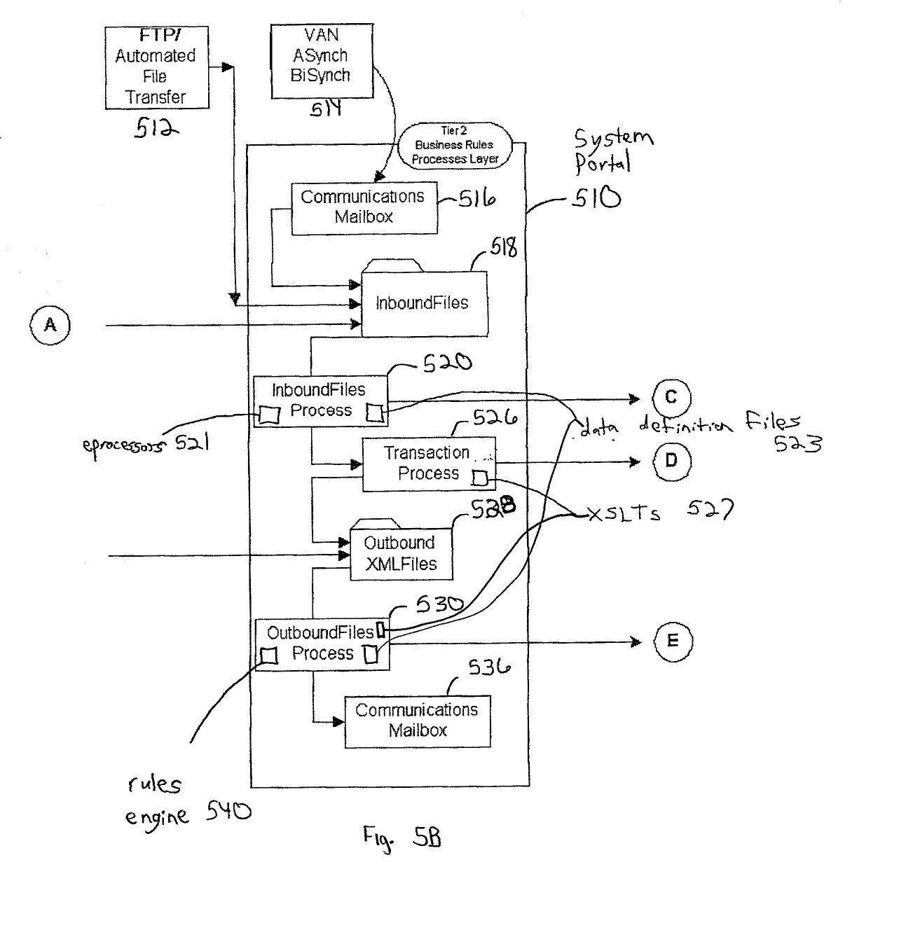

Now referring to FIG. 5, another embodiment of a system for exchanging data between trading partners according to the teachings of the present invention is illustrated. In FIG. 5, a process is illustrated that translates the file format of an incoming document sent by a Sending Company into XML. Such translation into XML facilitates efficient transformation of the incoming document's data format into a normalized data format more easily usable by a Receiving Company, while remaining in the XML file format. Aside from the significant savings in processing time obtained by transforming the data format using XML, the normalized XML document offers several additional advantages. For example, the normalized XML document enables both Sending and Receiving Parties to view the data using a standard web browser or other network graphical user interface. Additionally, the normalized XML document may be easily warehoused as an XML file. The normalized XML document may also be easily analyzed using a centralized set of business rules easily applied to XML files. Translating the document into XML also maintains the integrity of the original source data that may be lost in conventional EDI translation products. The extensibility of XML also allows a system host or customer to extend XML data formats without adversely affecting historical data entered using legacy XML data formats.

Additionally, the universal nature of XML ensures maximum flexibility in the development and translation environment by enabling the use of publicly available XML technologies such as DOM (Document Object Model) interfaces, SAX (Simple API for XML), Extensible Stylesheet Language Transformations (XSLT), and off-the-shelf treebased and on-demand parsers to easily customize XML documents. Additionally, XML is based on an open standard recommended by the W3C (World Wide Web Consortium) and is supported as an import and export standard to the latest version of most commercial databases. Such universal acceptance and support of the XML file format ensures easy portability of XML documents created using the present invention and allows outbound files in a format requested by a customer to be passed on to other applications used by a customer associated with order processing, fulfillment, accounting, multi-enterprise collaboration, supply chain management, procurement, vendor managed inventory, load tendering, track and trace, online catalogs, sales automation, process integration, digital exchanges, or other suitable subject matter. Thus, unlike electronic commerce translation products not using transformation to a normalized XML format, a system implemented according to the teachings of the present invention can be presented as a core platform for a complete, integrated solution for a product purchasing, inventory, and fulfillment solution.

A. Inbound Files Process

As described in reference to FIG. 1, data can be transferred to a system portal 510 from a Sending Company by any number of commercially reliable data communications methods including via an automated file transfer 512 or a VAN 514. Additionally, inbound data files may communicated from a Sending Company via personal digital assistants, cellular telephone, wireless pagers, or other suitable wireless network access devices. System portal 510 may also conduct a real-time load of data from the sending company's business system using software such as webMethods B2B Server. Once a data file is received by system portal 510, the data file undergoes an inbound files process 520. If the data file was received at a communication mailbox 516, it is moved to an inbound files directory 518. A system data agent monitors inbound files directory 518 for the presence of new files. Upon receipt of a new file, the system data agent identifies the format of the file using header information, sender identification, enveloping information, or other suitable information. The system data agent also identifies the sender of the file and desired recipients of the file.

Next, the system data agent scans the file and compares the file to a predetermined file format, as similarly described in process 202 of FIG. 2, in order to perform error checking and compliance checking. Error checking determines, for example, if the file received is a valid transaction request or if the file includes corrupted data. Compliance testing determines if the format of the data in the file complies with the predetermined file format. If the data file does not conform to the established structure or there is a failure or error detected during any part of this process, system portal 510 takes the following steps similar to those described in process 204 of FIG. 2: the data agent moves the data file to a temporary holding area; the notification handler sends a message indicating that an error occurred during this process to a system development organization via e-mail, pager, or some other comparable form of communication; the error is written to an error log file within the file system; and, an entry is written to an error log in a system database 522. Although this error checking and compliance testing procedure is described herein as separate from the procedure conducted by rules engine 540 as described below, the two procedures can be combined or otherwise modified without departing from the scope of the present invention. For example, all error checking and compliance testing may be postponed until after the data file has been converted into XML, provided that such conversion is not prevented by errors or the non-compliance of the data file.

Inbound files process 520 also creates a record of the data file for tracking purposes and storage in system database 522 that may include the size of the data file, the time and date at which the data file was received, the identification of the sender and recipients, the file format of the data file, the enveloping structure of the data file, and any other suitable information.

Inbound files process 520 may also include preprocessors 521 designed to perform a variety of actions on incoming data files before, during, or after the remaining processes of inbound file process 520 are performed. Preprocessors 521 allow system portal 510 to accept an even larger number of file formats. In particular, preprocessors 521 may: filter records from data files based on predetermined criteria; merge multiple data files into a single data file; accept and convert application files, such as a Microsoft Excel file, into a flat file format; and perform other suitable format and file manipulations. Thus, the presence of preprocessors 521 enable trading partners to avoid the need to alter how their systems create data files or convert such data files before transmitting them to each other.

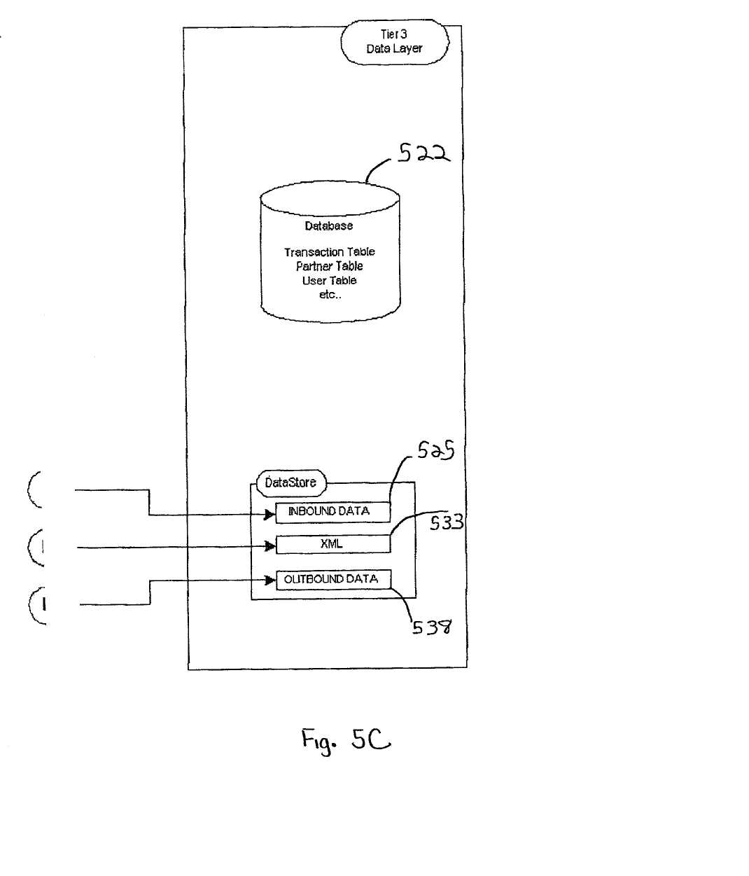

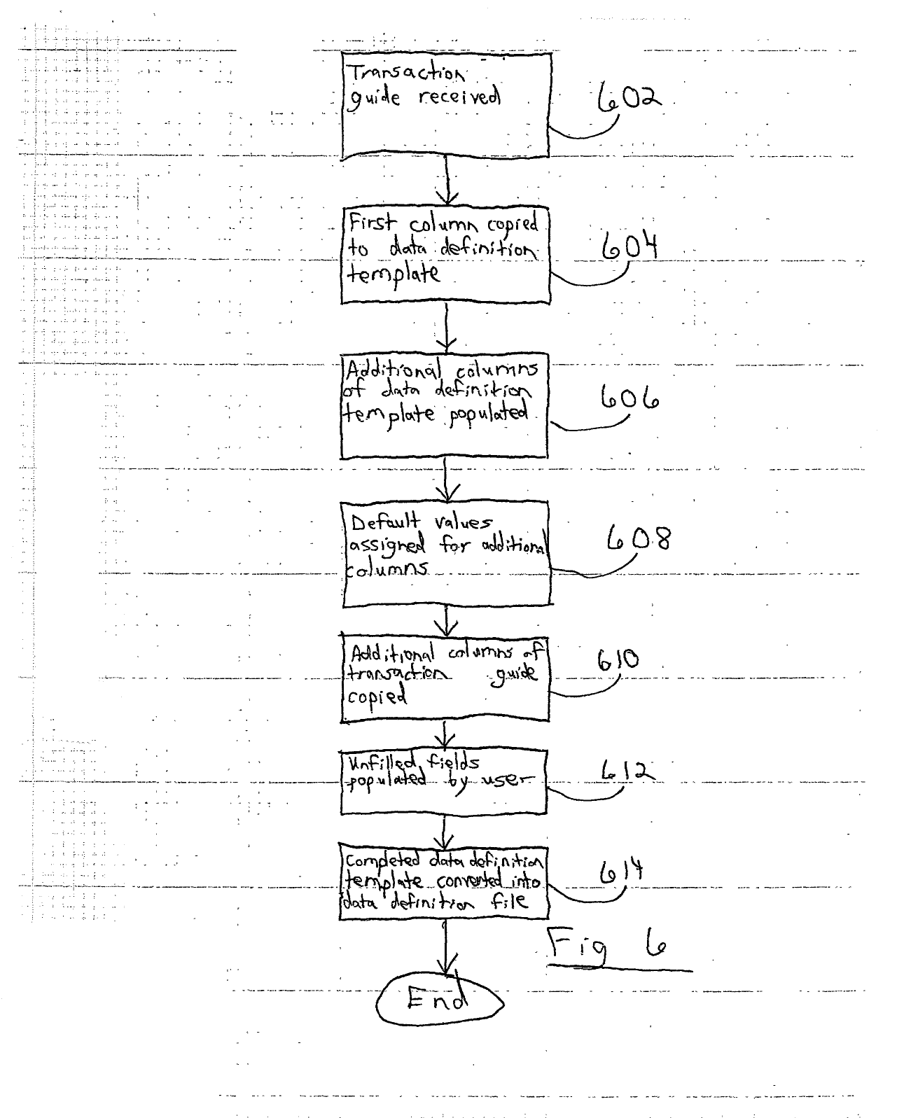

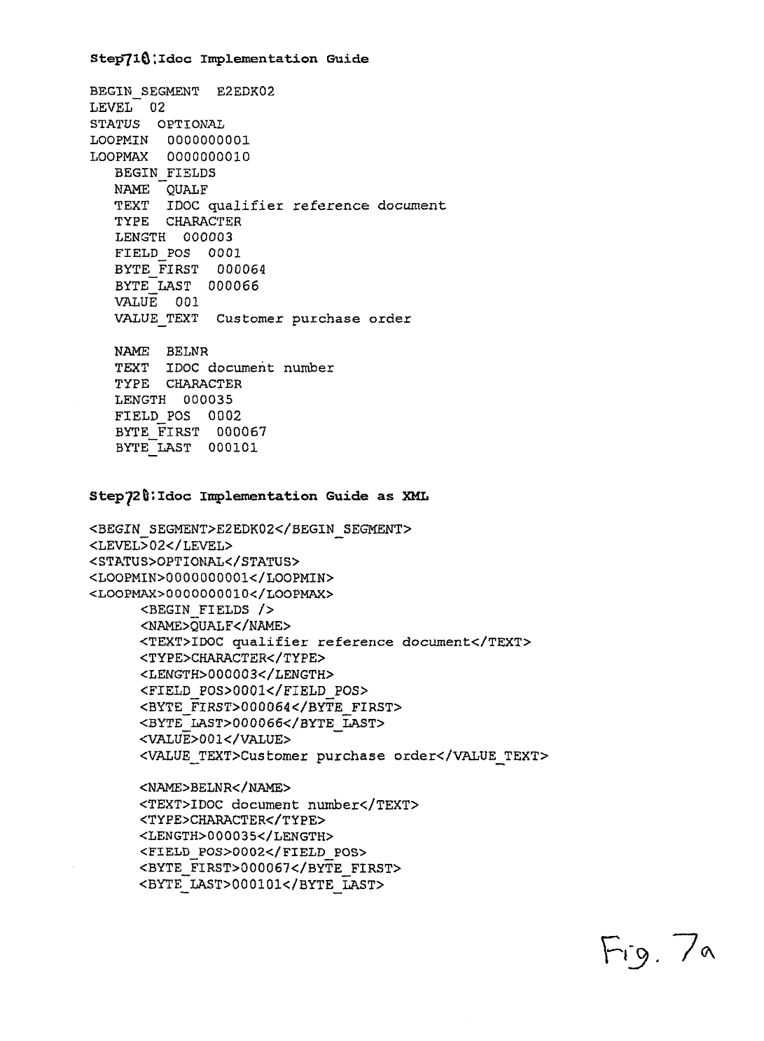

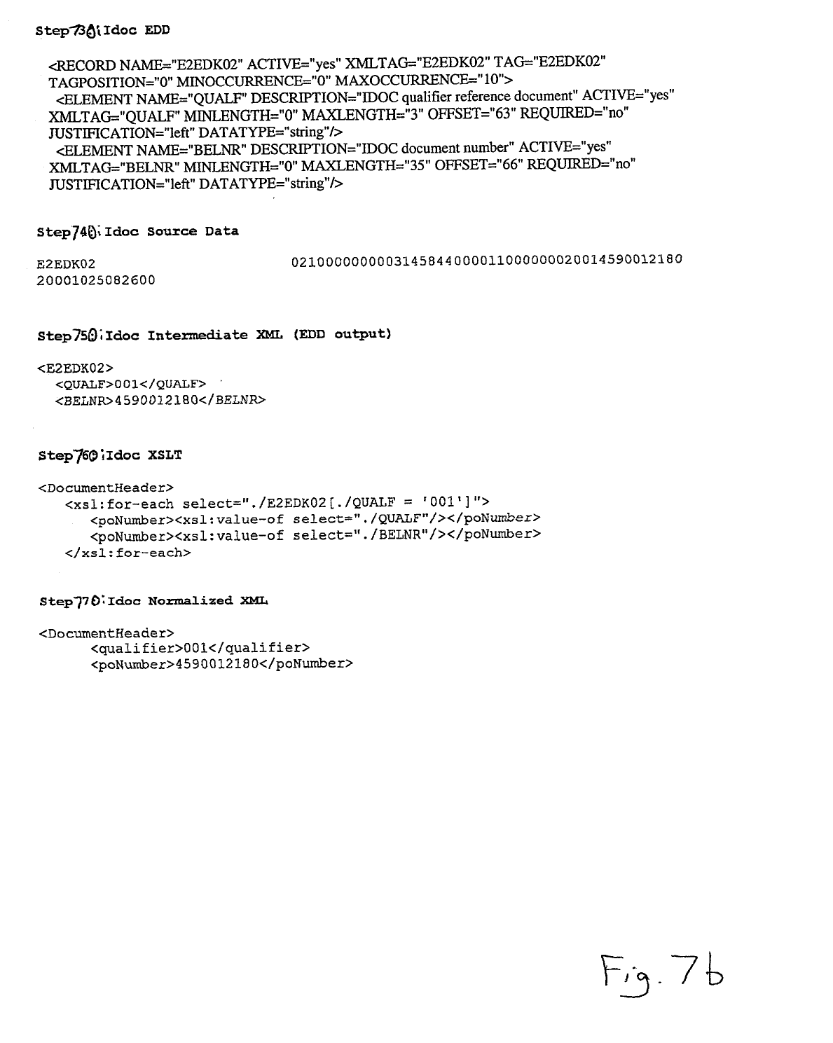

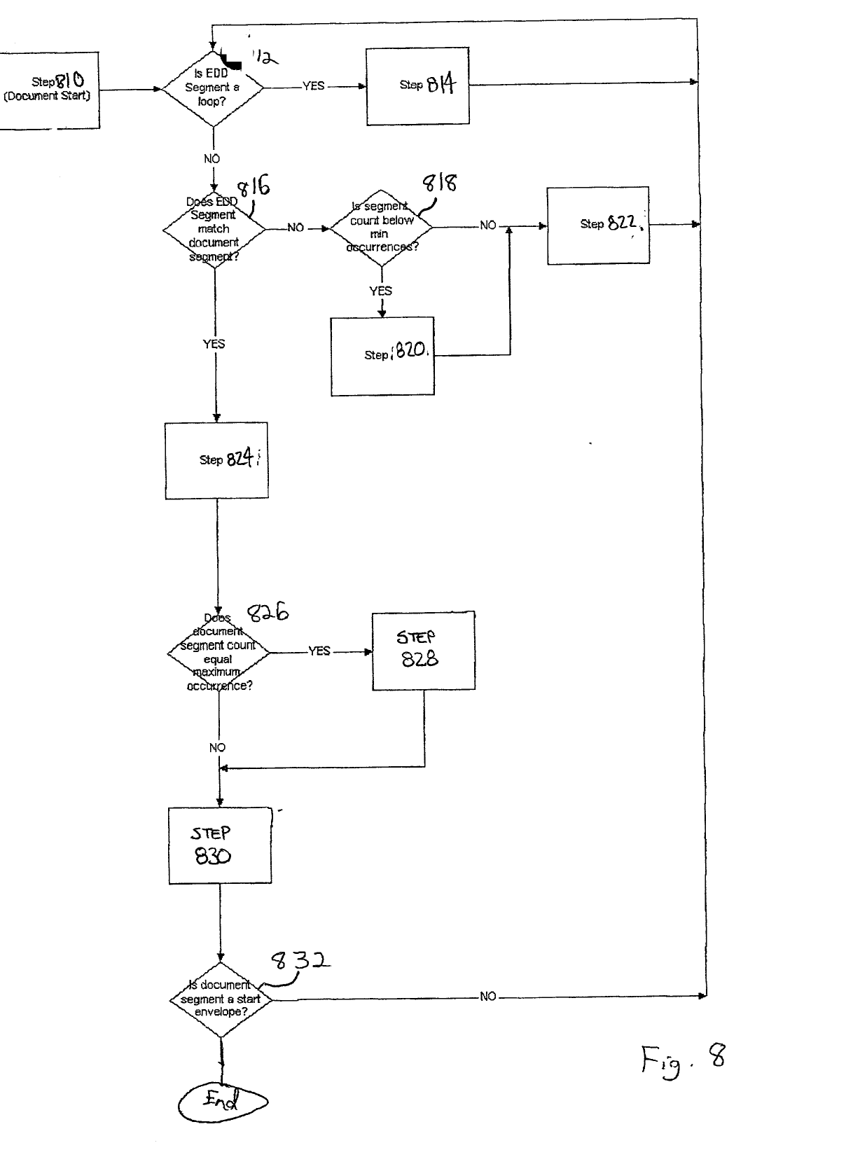

After the inbound file format has been checked for errors and compliance, and possibly manipulated by preprocessor 521, the file format of the original data file is translated to an XML file format in a transaction process 526 using one of data definition files 523. Data definition files 523 are XML files that describe the data format of data files received by system portal 510. For example, data definition files 523 may be maintained for: an EDI format; one or more flat file formats; SAP IDOC formats; formats associated with Baan, PeopleSoft, QuickBooks, or Great Plains; a comma or tab delimited format for bulk copy into a database or spreadsheet; or any other data format that a trading partner may use to submit electronic transactions. Various embodiments of the creation of one of data definition files 523 are described in FIGS. 6 and 7. As will be described, such embodiments and the characteristics of data definition files 523 enable rapid development and manufacture of data definition files 523 necessary to allow system portal 510 to handle new trading partner formats in a fraction of the time that would be required to construct the translation maps used by commercially available EDI translation software. One embodiment of using one of data definition files 523 to convert the file format of a data file to XML is illustrated in FIG. 8. Once converted, the data file is now an intermediate XML file that remains in a form consistent with the Sending Company's file format.

B. Transaction Process

After inbound files process 520 has completed successfully, transaction process 526 transforms the intermediate XML file into a normalized XML file using Extensible Stylesheet Language Transformations (XSLT) 527. XSLT files 527 are standard XML transform tools that may be used to quickly and easily transform the data from one XML structure to another structure (HTML, XML, flat files, EDI, custom delimited files, and other suitable formats) using an intuitive language. Aside from the general advantages of using XML as previously discussed, the time needed for the development of XSLT 527 to handle mapping of data between two new data formats is several times faster than the time needed to create a custom map needed for data transformation in traditional EDI translation software. Additionally, the process time for actually translating the file format of a data file into XML and then transforming the XML data file into a normalized XML data file is several times faster than the processing time required to translate/transform data files in traditional EDI translation software. Thus, using the present invention's processes incorporating the XML file format, data definition files 523, and XSLT 527 results in significant savings of time in development, deployment, and execution of customized electronic data transaction processes. Additionally, any of the XML files, data definition files 523, or XSLT 527 may be edited using a simple text editor or XML editor, making maintenance, modification, customization, and extension a quick, easy process that does not require a significant delay before adoption by a customer.

Upon the completion of the transformation to the normalized XML file, the data translation process outputs the normalized XML file to outbound XML files directory 528 to await processing by an outbound files process 530. Additionally, the normalized XML file may be stored in an XML datastore 533 for communication to the Receiving Company, recording purposes, decision support analysis and reporting, or display via web-browser, personal digital assistants, cellular telephone, wireless pagers, or other suitable wireless network access devices.

In one embodiment, a forms-capable web browser or other user interface can be used by the Sending Company to submit a purchase order or other desired transaction by filling out the fields of a browser form 529. In such an embodiment, the fields of browser form 529 may be configured to correspond directly to the elements of the normalized XML file format. Thus, when the Sending Company submits browser form 529 electronically, it may be automatically converted to a normalized XML file thereby avoiding the need for the transformation described herein. In such an embodiment, the normalized XML file would be placed directly in XML files directory 528. In yet another embodiment, a Sending Company who has previously submitted a purchase order or other desired transaction may use a browser form 529 to view the purchase order, modify the elements of the purchase order, and view any such modifications. Additionally, a user at the Sending Company, the Receiving Company, or at an authorized third party may view the status of the purchase order, and may additionally select links or view data associated with applications that may include information connected to the purchase order such as manufacturing, inventory, or fulfillment applications.

C. Outbound Files Process

Outbound files process 530 applies compliance and business rules to analyze the normalized XML data files and communicates outbound files, whether in XML format or any other file format, to the Receiving Company. Additionally, outbound files process 530 may transform normalized XML data files into an XML format consistent with one of data definition files 523 associated with a Receiving Company's desired data format. In one embodiment, outbound files process 530 may translate the XML data files to a file format specified by the Receiving Company or required for a particular application or system of the Receiving Company. Such translation is accomplished using one of the data definition files 523 as described with reference to transaction process 526. This translation process can occur automatically or dynamically as described in FIG. 1.

Outbound files process 530 includes a rules engine 540 that is designed to apply standard and customer-specific business rules to each and every data file that flows through the system (including those generated from the web, from integrated third-party systems, or from the B2B document processing engine). Although described here in outbound files process 530, rules engine 540 may be located in inbound files process 520 or directly within transaction process 526. Rules engine 540 is centrally located and is not tied to any particular form, method of transport, or Sending Company's data format. Instead, rules engine 540 may be a repository for all business rules used by system portal 510. Rules engine 540 may take advantage of the normalized format of the normalized XML data files to use a process that applies rules to the data in a normalized XML data file where the rules have been particularly adapted to the normalized format. This process allows the rules to be applied against a common XML structure thus simplifying the process of creating, implementing, and applying the rules. In addition, standard rules that are not transaction specific (such as data type checking, bounds checking, value filtering, etc.) can be built once and applied over and over to different document types as all of such types are in XML format.

In particular, the standard rules used by rules engine 540 perform the following common operations: data type checking, bounds checking, value mapping, data transformation, and compliance checking. Data type checking includes validating the data type of the element (e.g. date/time, numeric, string, etc.) and the precision/scale (for numeric data) or maximum length (for strings). Bounds checking is used for numeric data to verify that the value is above a certain threshold, below a certain threshold, or between a minimum and maximum value (either inclusively or exclusively). Value mapping is used to map data in a field from one value to another through a database lookup (for instance, there may be a code coming in as “FR” in a certain field that needs to be mapped to the value “FRENCH”). Data transformation is used to change the structure of the document by moving data into and outside of loops (where a loop is a repetition of a particular record in the document). Compliance checking is used to validate the structure of the document by checking that certain records and elements that are marked as required or that repeat for a finite range (e.g. there can be up to three names in the billing contact record, but no more than three) actually meet these requirements. All of the standard rules can be applied to documents by simply entering the configuration information about a document type through a user-interface of rules engine 521.

More complex business rules that are specific to a customer's business needs can be defined and implemented in rules engine 521 by a developer writing the rule using a programming tool such as Microsoft Visual Basic, Microsoft C++, or Java. These customer rules can be defined as one of two types: validation rules or transformational rules. Validation rules are applied first and can be used to validate the content, structure, or internal relationships in the document. If a validation rule fails then the transformational rules are not run. Transformational rules change the content of that document or of another associated document (for example, when a purchase order is received, a transformational rule could run to update the unit price field with a price from a database or catalog).

When rules engine 521 is passed a data file, rules engine 521 queries database 522 for rules that have been defined for this particular type of document represented by the data file. The document type is easily determined by interrogating the document type element of the normalized XML data file. The document type element is contained in every normalized XML data file. If the query returns a result, rules engine 521 begins to apply the rules that were returned by the query.

If the rules are all successfully completed, the document is passed to the next step within processes 520, 526, or 530. If the process is for inbound documents, the file is moved to an appropriate mailbox or file directory. If the process is for outbound documents, the file is moved to the appropriate directory where the data transformation tool can pick up the file for outbound transformation. If any of the rules fail, the transaction is marked as rejected in both the Sending Company's outbox and the Receiving Company's inbox, the file is written to a holding area, and system portal 510 sends a notification (e-mail, pager, or some other comparable form of communication) to a support or development team as well as the sender of the data to notify them of the problem.

Outbound files process 530 also inserts outbound files into the Receiving Company's communications mailbox 536, in any suitable file format requested by Receiving Company. Upon the arrival of an outbound data file, the outbound post-translation data agent opens the file and retrieves the record ID that was seeded into the XML file. After retrieving the record ID, the data agent queries the system database 522 so that the outbound post-translation process can update this record with the name of the outbound data file and store the outbound data file in an outbound data repository outbound datastore 538.

Upon the completion of this outbound post-translation process, the data file is sent or picked up by the recipient trading partner depending on their desired method of receipt. System portal 510 provides several different methods for delivering the documents to the intended recipient company. As described above, one such method is to place the document in the recipient company's system mailbox for download by the Receiving Company. Alternatively, the data can be sent directly to the Receiving Company using a communications software such as Cyclone Software. Another alternative provided by the system, is the ability to insert the data real-time into the Receiving Company's business system using software such as webMethods B2B Server. The system also can transmit the data to the Receiving Company's mailbox or a Value-Added Network using any commercially available communications protocol.

Because the system translates the source data file into an XML format, the system offers several options on how the data can be presented to the users. The static XML data can be presented through the Receiving Company's system mailbox in an HTML form. The static XML data also can be presented with dynamic data from alternate data repositories in an HTML form. Additionally, the raw XML data may be displayed by downloading the XML file and displaying the data in a Web browser or a third party application. Additionally, an outbound data file may communicated to a Receiving Company via personal digital assistants, cellular telephone, wireless pagers, or other suitable wireless network access devices. As described above, the present invention offers several advantages in the way the data is sent and displayed. In particular, system portal 510 may be configured to automatically notify the sender or receiver of the document when certain business conditions are met. System portal 510 may notify the sender, receiver, and/or third party with a custom message when: a document arrives in their in-box; a document is rejected or fails compliance checking; a document meets custom defined exception conditions (for instance, if a document was sent and has not been read in three days time, a reminder can be sent to the recipient); or upon any other suitable event or condition. Moreover, any of these notifications may be custom messages that can include information from the document involved. Again, many of these capabilities and the integration of applications required to provide these capabilities are a direct result of using XML and the flexibility XML provides.

Although the components of system portal 510 and other components of FIG. 5 are illustrated as separate databases, processes, engines, modules, subsystems and other illustrated components, each of such separate components may be implemented using a single processor such that the single processor accesses stored algorithms, executables, files, and other software or data that are stored in read-only memory, for example, and executed using random access memory. Likewise, such databases, processes, engines, modules, subsystems and other illustrated components may be combined, separated or distributed across one or more processing and/or memory devices. Memory for such databases, processes, engines, modules, subsystems and other illustrated components may be implemented using one or more files, data structures, lists, or other arrangements of information stored in one or more components of random access memory, read-only memory, magnetic computer disks, compact disks, other magnetic or optical storage media, or any other volatile or non-volatile memory.

Now referring to FIG. 6, a flowchart of one embodiment of a method of generating one of data definition files 523 is illustrated. In step 602, a flat file transaction guide is received from a trading partner. The flat file transaction guide is also referred to as an implementation guide and is a description of the electronic format used by the trading partner for a particular type of transaction file such as, for example, a purchase order. The transaction file guide is preferably provided in a columned format such as a spreadsheet. Alternatively, the transaction file guide may be converted to a columned format within step 602.

In step 604, the first column of the transaction file guide (corresponding to the names or identifications of data element) is copied to the first column of a data definition template. In step 606, additional columns of the data definition template are populated with fields corresponding to the data elements copied into the first column of the data definition template. For example, fields may be populated that correspond to starting character positions, ending character positions, field length, field termination codes, format, the mandatory nature of the copied data elements, or any other suitable data regarding the format and nature of the data elements. In step 608, default values may be assigned for each field populated in step 606. In step 610, other values for fields populated in step 606 may be filled in by copying additional columns of the transaction file guide. In step 612, values remaining unfilled in the data definition template may be populated by a user or automatically by an automated process.

In step 614, the completed data definition template is automatically converted into one of data definition files 523 in XML file format. Thus, a transaction file guide supplied by a trading partner can be used to create one of data definition files 523 that includes all necessary data for the process described in FIG. 5 to interpret and translate the particular type of transaction file referenced by the transaction file guide.

A particular company using the process described herein to create data definition files 523 may have a default data definition file 523 and default transformation 527 that is used with the majority of its trading partners, and may have separate, specialized data definition files 523 and transformations 527 to interact with those trading partners that do not utilize the default data definition file 523 and default transformation 527. In such a manner, the company does not need to maintain separate data definition files 523 and transformations 527 for each trading partner but only a default data definition file 523 and transformation 527 and a limited number of specialized data definition files 523 and transformations 527. Likewise, when viewing information associated with a transaction document type for the company and all of its trading partners, a single screen may be used to represent the format of the transaction document type for thousands of trading partners, represented in the form of the default data definition type 523 and a list of trading partners that are exceptions to the default data definition type 523. Thus, exception-based treatment of trading partners and transaction document types used thereby significantly reduces development time, needed memory and processing capacity, and allows a user to be easily presented with an overall picture of how a company's trading partners interact with the company in electronic commerce.

Now referring to FIG. 7, a diagram of an alternative embodiment of a method of generating one of data definition files 523 is illustrated. In particular, FIG. 7 illustrates the conversion of a transaction file guide in SAP IDOC format into an XML document that is in turn used to create one of data definition files 523. FIG. 7 also illustrates the use of the created data definition file 523 to translate and transform an IDOC transaction data file into a normalized XML data file.

In step 710, an automated process, an IDOC implementation guide illustrating two fields is received as illustrated. In step 720, as illustrated, an XML representation of the implementation guide is created by mapping the first column of data from the implementation guide into XML element tags and mapping the second column of data into XML element data corresponding to each element tag. In step 730, an associated data definition file 523 is created corresponding to the IDOC implementation guide using data from the XML representation and an XSLT used to transform data in the XML representation into the proper format of the associated data definition file 523. Newly created data definition file 523 may be modified by a user, if necessary.

Steps 740 through 770 describe the use of the created data definition file 523 to translate and transform a data file. In step 740, IDOC source data is received in a data file. In step 750, the data file is converted into an intermediate XML data file (in XML file format) using data definition file 523 as described in FIG. 8. In step 760, XSLT is generated in response to a comparison of data definition file 523 and a Receiving Company's XML format for the transaction. In step 770, the XSLT is utilized to transform the intermediate XML data file into a normalized XML data file.

In an alternative embodiment, one of data definition files 523 may be created in real time in response to examining a transaction data file. For example, a user may provide a non-binary data file without specifying either the syntax or semantic information for its contents. The syntax of the structures within the file may then be determined in real-time solely by examining the file contents. The user then has the opportunity to correct or augment these automatically derived structures, without the need for re-analyzing the file contents. Immediate feedback is provided on the user's changes. Once satisfied with the file partitioning results, the user may then accept the defined structure. At this point, the characterization of file for translation is complete. The specification can then be formatted for use with the translation process described in FIG. 5. In yet another embodiment, a data definition file 523 for X12 and Edifact, for example, may be dynamically created from publicly available standards definitions which allow the creation of a data definition file library comprising all X12 and Edifact standards.

Additionally, the user may not only provide a source file but also one or more sets of destination or output files that are known to be derived from the source file. The model described above then extends to all the data sets provided, which results in not only the descriptions of the structures for each file, but also the translation mechanisms between the source and output files, automating the process end-to-end. The sole requirement on the input files is that they be character encoded. Unlike other translation products, this is unique in being able to handle unstructured data of any kind. Analysis may also be done in a fully automated, unattended fashion. User intervention is required only to augment or correct automatic structure definitions and to accept the resultant structure definitions. When matched sets of input and output files are provided by the user, the setup and generation of the translation framework can be fully automated.

Now referring to FIG. 8, a flowchart of one embodiment of a process of using one of data definition files 523 to translate a data file into XML format is illustrated. In step 810, the first segments of a particular data definition file 523 and the data file to be translated are retrieved. In step 812, the process determines if the retrieved segment of the particular data definition file 523 is a loop. If the retrieved segment is a loop the first segment within the loop is retrieved in step 814 and the process returns to step 812. If the retrieved segment is not a loop, then the process determines in step 816 if the retrieved segment of the particular data definition file 523 matches the retrieved segment of the data file. If it does not match, the process determines if the total segment count is below the minimum number of occurrences, as defined in data definition file 523 in step 818. If it is not, the next segment of the particular data definition file 523 is retrieved in step 822 and the process returns to step 812. If it is, a compliance failure is recorded in step 820 and control proceeds to step 822.

If the retrieved segments are determined to match in step 816, an XML representation for the segment is created in step 824 and the segment count is increased. Then, in step 826, the process determines if the maximum occurrence of the segment count, as defined in data definition file 523, has been reached. If it has, the next segment of the particular data definition file 523 is retrieved in step 828. In any case, the next data file segment is retrieved in step 830. In step 832, the process determines if the next data file segment is a start envelope. If it is, the process terminates with respect to that particular data file. If not, the process returns to step 812.

Having described and illustrated the principles of the invention in a preferred embodiment thereof, it should be apparent that the invention can be modified in arrangement and detail without departing from such principles. We claim all modifications and variations coming within the spirit and scope of the following claims.

What is claimed is:

1. A method of processing data exchanged between a first trading partner and a second trading partner, the method comprising:
receiving a first data file from the first trading partner, the first data file having a first file format and being an electronic representation of at least one document;
translating the received first data file into at least one second data file having an XML file format, wherein the received first data file is translated using at least one data definition file associated with the at least one document, the at least one data definition file being used to translate the first data file into the at least one second data file; and
transforming the at least one second data file into a normalized third data file having an XML file format, wherein the third data file is normalized according to a data format associated with the second trading partner.

2. The method of claim 1, and further comprising translating the normalized third data file from an XML file format into a file format requested by the second trading partner.

3. The method of claim 1, and further comprising accessing an XSLT associated with one of the at least one second data files, the XSLT being used to transform the one of the at least one second data files into the normalized third data file.

4. The method of claim 1, and further comprising processing the received first data file to determine if the first file format should be modified before the received first data file is translated into the at least one second data file.

5. The method of claim 1, and further comprising displaying the normalized third data file using a web browser in human-readable format.

6. The method of claim 5, and further comprising receiving modifications to the displayed third normalized data file, such modifications being made by altering data in fields of the normalized third data file using a browser form.

7. The method of claim 1, and further comprising communicating a data file corresponding to one or more portions of the normalized third data file to a inventory tracking application of the second trading partner.

8. The method of claim 1, and further comprising communicating a data file corresponding to one or more portions of the normalized third data file to an order fulfillment application of the second trading partner.

9. The method of claim 1, and further comprising:
translating the normalized third data file into a fourth data file having a file format desired by the second trading partner; and
communicating the fourth data file to the second trading partner in the desired file format.

10. A method of generating a data definition file, the data definition file being used to translate a data file between a first file format and an XML file format, the method comprising:
receiving an implementation guide associated with the first file format, the implementation guide defining the fields of the first data file;
generating an XML representation of the implementation guide; and
generating the data definition file using the XML representation of the implementation guide.

11. A system for processing data exchanged between a first trading partner and a second trading partner, the system comprising a processor and memory, the processor operable to execute:
a first process operable to determine the file format of a first data file received from the first trading partner and further operable to translate the first data file into a second data file having an XML file format in response to the determined file format and a data definition file;
a second process in communication with the first process and operable to transform the second data file into a normalized third data file, wherein the third data file is normalized according to a data format associated with the second trading partner; and
a third process in communication with the second process and operable to apply business rules to the normalized third data file.

12. The system of claim 11, wherein the third process is further operable to communicate the normalized third data file to a mailbox associated with the second trading partner.

13. The system of claim 11, and further comprising a preprocessor in communication with the first process, the preprocessor operable to modify the file format of the first data file in response to determining the file format of the first data file prior to the translation.

14. The system of claim 11, wherein the data definition file is an XML file that includes elements generated in response to an implementation guide.

15. The system of claim 11, and further comprising an XSLT associated with one of the second data file, the XSLT being used by the second process to transform the second data file into the normalized third data file.

16. The system of claim 11, and further comprising a rules engine used by the third process to analyze the normalized third data file to determine compliance with a set of rules.

17. The system of claim 16, wherein the set of rules is selected in response to a transaction type determined by interrogating the document type element of the normalized third data file.

18. The system of claim 16, wherein the rules engine includes standard rules and customer specific business rules.

19. The system of claim 18, wherein the standard rules include error-checking rules and compliance rules.

20. The system of claim 18, wherein the customer specific business rules include validation and transformational rules.

21. The system of claim 11, and further comprising a communications mailbox, the communications mailbox operable to generate a message to the first trading partner or the second trading partner in response to a predetermined event.

22. The system of claim 21, wherein the predetermined event is a rejection of a document associated with the third normalized data file.

23. The system of claim 21, wherein the predetermined event is an exception condition.

24. The system of claim 21, wherein the message is customized to the third normalized file.

25. The system of claim 21, wherein the message includes data from the third normalized data file.

26. A method of conducting electronic commerce by translating a data file between a first file format associated with a first trading partner and an XML file format associated with a second trading partner, the method comprising:
receiving the data file;
determining a file format of the data file;
accessing a data definition file associated with the file format;
comparing each segment of the data definition file to each segment of the data file; and
generating an XML element in response to each match determined between the compared segments.

27. The method of claim 26, wherein the data definition file is generated in response to an implementation guide received from the first trading partner.

28. The method of claim 26, wherein the data definition file is an XML file.

29. The method of claim 26, wherein comparing each segment of the data definition file to each segment of the data file further comprises determining a location of the segment of the data file in response information included in the data definition file.

30. The method of claim 26, wherein generating an XML element further comprises generating an element tag and associated element data from information included in the matched segment of the data file.
